(19) United States
(12) Patent Application Publication
(10) Pub. No.: US 2026/0050963 A1
(43) Pub. Date: Feb. 19, 2026

(54) RECALL METHOD, RECALL DEVICE, AND READABLE MEDIUM FOR E-COMMERCE RECOMMENDATION SYSTEM

(71) Applicants: Guangzhou Xiyin International Import and Export Co., Ltd., Guangdong (CN); Nanjing Xiyin Ecommerce Co., Ltd., Jiangsu (CN); Shenzhen Xiyin Information Technology Co., Ltd., Guangdong (CN)

(72) Inventor: WEIBIN LUO, Guangdong (CN)

(21) Appl. No.: 18/956,490

(22) Filed: Nov. 22, 2024

(30) Foreign Application Priority Data
Aug. 16, 2024 (CN) 202411133958.8

(51) Int. Cl. G06Q 30/0601

(52) U.S. Cl. CPC G06Q 30/0631

(57) ABSTRACT

A recall method for an e-commerce recommendation system includes performing a full Swing calculation, based on a full user behavior sequence in the e-commerce recommendation system, to obtain a full Swing result, calculating first Swing similarity of a user behavior sequence of a previous day according to the full Swing result, performing a fusion of the first Swing similarity and second Swing similarity of a historical user behavior sequence, to obtain a target Swing result, and utilizing the target Swing result to update the first Swing similarity of the previous day, and using it as a historical Swing result of a next day, to realize a recall in the e-commerce recommendation system. By using the solution of the present application, resource consumption may be reduced and recall efficiency may be improved.

### CROSS REFERENCE TO RELATED APPLICATIONS AND CLAIM OF PRIORITY S

This application claims the benefit under 35 USC § 119 of Chinese Patent Application No. 202411133958.8 filed on Aug. 16, 2024, in the Chinese Intellectual Property Office, the entire disclosure of which is incorporated herein by reference for all purposes.

### BACKGROUND

### 1. Technical Field

The present application generally relates to the technical field of recall of the recommendation system, and more specifically, to a recall method, a recall device, and a non-transitory machine-readable medium for the e-commerce recommendation system.

### 2. Background Art

Swing algorithm is a recall algorithm, wherein, Swing is a relational graph similar to a swing, that is, for each item, all users who clicked it and all items clicked by these users form a user-item-user network structure partial graph called Swing. Swing indicates similarity relationship between items, and this similarity relationship is transmitted through user relationships.

Swing algorithm is a full-graph recall algorithm based on the user-item. Its essence is the normal form of memory base in the i2i algorithm (a general term for a series of algorithms that recommending based on similarity between items), which is a parameter-free algorithm for data statistics. However, in the calculation process of the full-graph Swing algorithm, there are two data bloat processes. One is to traverse the user behavior sequence and form item pairs (such as <i, j>), and the other is that the item pairs <i, j> are expanded by item pairs clicked by users (such as u, v). In these two data bloating processes, the two expansions consume memory and the two aggregations consume calculation, so that each full-graph calculation consumes both time and resource, affecting the recall effect.

In view of this, there is an urgent need to provide a recall solution for the e-commerce recommendation system in order to reduce resource consumption and improve recall efficiency.

### SUMMARY

In order to solve at least one or more technical problems mentioned above, the present application proposes a recall solution for the e-commerce recommendation system in multiple aspects.

In a first aspect, the present application provides a recall method for an e-commerce recommendation system, including: performing a full Swing calculation, based on a full user behavior sequence in the e-commerce recommendation system, to obtain a full Swing result; calculating first Swing similarity of a user behavior sequence of a previous day according to the full Swing result; performing a fusion of the first Swing similarity and second Swing similarity of a historical user behavior sequence, to obtain a target Swing result; and utilizing the target Swing result to update the first Swing similarity of the previous day, and using it as a historical Swing result of a next day, to realize a recall in the e-commerce recommendation system.

In a second aspect, the present application provides a recall device for an e-commerce recommendation system, including: a memory having stored thereon computer instructions used to recall in the e-commerce recommendation system, and when the computer instructions are executed by the processor, the recall device implements the embodiments of the aforementioned first aspect.

In a third aspect, the present application provides a non-transitory machine-readable medium having stored thereon computer program instructions used to recall in an e-commerce recommendation system, wherein when the computer program instructions are executed by one or more processors, the embodiments of the aforementioned first aspect are implemented.

Through the recall solution for the e-commerce recommendation system provided above, the embodiments of the present application perform the full Swing calculation based on the full user behavior sequence to ensure that the item does not omit the full-graph information, so the lossless Swing algorithm is guaranteed. Compared with the existing recall methods, the embodiments of the present application only need to calculate the first Swing similarity of the user behavior sequence of the previous day, perform a fusion of the first Swing similarity and second Swing similarity of the user behavior sequence, and then update the Swing result of the previous day. There is no need to traverse all user behavior sequences and expand all item pairs every time, which greatly improves the recall efficiency and reduces resource consumption. Furthermore, the embodiments of the present application also ensure the stability of the algorithm and the data in the recall by setting hyperparameters in the Swing calculation.

### BRIEF DESCRIPTION OF THE DRAWINGS

By reading the detailed description below with reference to the drawings, the above and other purposes, features and advantages of the exemplary implementation methods of the present application will become easy to understand. In the drawings, several implementation methods of the present application are shown in an exemplary and non-limiting manner, and the same or corresponding reference numerals represent the same or corresponding parts, wherein:

FIG. 1 is an exemplary schematic diagram showing a user-item;

FIG. 2 is an exemplary flow block diagram showing a recall method for an e-commerce recommendation system according to an embodiment of the present application;

FIG. 3 is an exemplary schematic diagram showing a recall method for an e-commerce recommendation system according to an embodiment of the present application;

FIG. 4 is an overall exemplary flow block diagram showing a recall method for an e-commerce recommendation system according to an embodiment of the present application;

FIG. 5 is an exemplary structural block diagram of a recall device for an e-commerce recommendation system according to an embodiment of the present application.

### DETAILED DESCRIPTION

The technical scheme in the embodiments of the present application will be clearly and completely described in conjunction with the drawings attached to the embodiments of the present application. Obviously, the embodiments described are part of the embodiments of the present application, but not all embodiments. Based on the embodiments of the present application, all other embodiments obtained by a person skilled in the art without performing creative work are within the scope of protection in the present application.

It should be understood that the terms “include” and “comprise” used in the specification and claims of the present application indicate the existence of described features, wholes, steps, operations, elements and/or components, but do not exclude the existence or addition of one or more other features, wholes, steps, operations, elements, components and/or collections thereof.

It should also be understood that the terms used in the specification of the present application are only for the purpose of describing specific embodiments and are not intended to limit the present application. As used in the specification and claims of the present application, unless the context clearly indicates otherwise, the singular forms of “a”, “an” and “the” are intended to include plural forms. It should also be further understood that the term “and/or” used in the specification and claims of the present application refers to any combination of one or more of the associated listed items and all possible combinations, and includes these combinations.

As used in the specification and claims, the term “if” may be interpreted as “when” or “once” or “in response to determining” or “in response to detecting” depending on the context. Similarly, the phrases “if it is determined” or “if [described condition or event] is detected” may be interpreted as meaning “once determining” or “in response to determining” or “once detecting [described condition or event]” or “in response to detecting [described condition or event]” depending on the context.

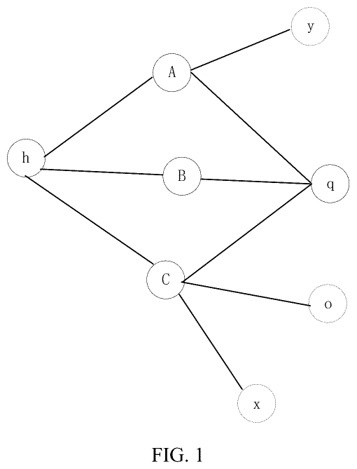

As may be seen from the above background technology description, Swing is a relational graph similar to a swing. As an example, suppose that both User u and User v have purchased the same Item i, then a swing-like relationship is formed among them. Assuming that User u and User v have purchased Item j besides Item i, it is considered that the two items are similar to some extent. In other words, the similarity relationship between items is transmitted through user relationship. In order to measure the similarity between Item i and Item j, User u and User v who have both purchased Item i and Item j are examined. The fewer items both of the two users have purchased, the more similar Items i and j are, and wherein, the Swing similarity may be expressed by the following formula:

$$sim < i , j >= {\sum }_{u ϵ {U}_{i} ⋂ {U}_{j}} {\sum }_{v ϵ {U}_{i} ⋂ {U}_{j}} \frac{1}{α + \vert {I}_{u} ⋂ {I}_{v} \vert} \qquad ( 1 )$$

wherein Uᵢ represents the set of users who like Item i, Uⱼ represents the set of users who like Item j, Iᵤ represents the set of items liked by User u, and Iᵥ represents the set of items liked by User v. The two sigma sums in the formula represents obtaining user pairs, each of which contains two elements, and each element of the user pair is within the set of users who like Item i and j at the same time. The numerator 1 represents a user <u, v> pair. The intersection of Iᵤ and Iᵥ is used to represent the similarity between User u and v, which is equal to the number of items clicked by both of the two users. The higher this value is, the higher the contact ratio between the two users, and its contribution ratio should be reduced. α is a smoothing term that may avoid the denominator being zero, and α may be taken as a smaller positive number, such as 1. The following will describe the calculation of Swing similarity in detail in conjunction with FIG. 1.

FIG. 1 is an exemplary schematic diagram showing a user-item. As shown in FIG. 1, it is assumed that A, B, and C represent three different users, and h, y, q, o, and x all represent items. The diagram exemplarily shows that all of User A, B, and C have clicked on Item h, and all of User A, B, and C also have clicked on Item q, too. In addition, User C also has clicked on Item y, and User C also has clicked on Item o and Item x. According to the previous article, for each item, all users who have clicked on it and all items clicked by these users form a user-item-user network structure partial graph called Swing. As an example, for Item h, User A and B both have clicked on Item q, so [A, q, B] forms a Swing structure. Similarly, [A, q, C] and [B, q, C] also respectively form a Swing structure.

In actual application scenarios, when calculating Swing similarity, firstly, forming item pairs, such as Item Pair <h, y>, <h, q>, <h, o>, and <h, x>. Then, the number of user pairs and items clicked by both two users may be determined based on the Swing structure, and the contribution ratio of the common clicks under each pair of users may be summed to obtain the Swing similarity. That is, the Swing similarity is calculated based on the above formula (1). Among them, the above smoothing coefficient α may be set to 1.

For example, to calculate similarity between the item pair <h, q> is taken as an example, since the respectively common click of user pairs [A, B], [B, C] and [A, C] is only q, the contribution ratio of the Swing structures of [A, B], [B, C] and [A, C] to q is 1/(1+1), so the Swing similarity of <h, q > is:

$$sim < h , q >= \frac{1}{2} + \frac{1}{2} + \frac{1}{2} .$$

Similarly, similarity of <h, y>, <h, o> and <h, x> may also be obtained, and the items are subsequently sorted according to the similarity, to realize a recall.

Based on the above description, in the calculating process of the full-graph Swing algorithm, it is necessary to traverse a user behavior sequence each time, form item pairs, and expand the item pairs expanded by item pairs clicked by both of users. This makes each full-graph calculation both time-consuming and resource-consuming, affecting the recall effect.

Based on this, the present application proposes a recall solution for the e-commerce recommendation system, which greatly reduces resource consumption and improves recall efficiency, by calculating the full-graph Swing only once when the task is started and only calculating the Swing result of a previous day each time.

The specific implementation methods of the present application are described in detail below with reference to the drawings.

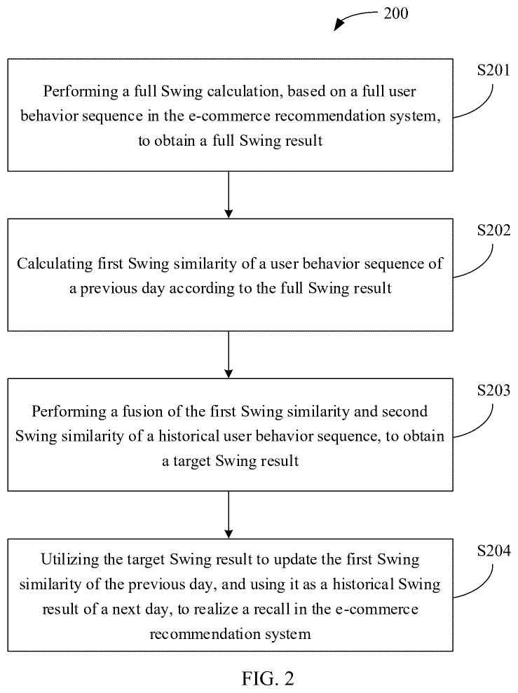

FIG. 2 is an exemplary flow block diagram showing a recall method 200 for an e-commerce recommendation system according to an embodiment of the present application. As shown in FIG. 2, at step S201, performing a full Swing calculation, based on a full user behavior sequence in the e-commerce recommendation system, to obtain a full Swing result. It is understandable that the full user behavior sequence in the aforementioned e-commerce recommendation system refers to all user behavior sequences in the database at the current moment, which is also called full data. That is, performing a full Swing calculation based on the full data. This only calculates the full-graph Swing once when the task is started as an initial recall version. In an implementation scenario, a full Swing calculation may be performed based on the above formula (1) to obtain a full Swing result. In some embodiments, the aforementioned user behavior sequence is a list set formed when the user performs target operations on a target item at different times, and the target operations include at least a click operation. In addition, the aforementioned target operations may also include operations such as placing an order, adding into a cart, and collecting.

Next, at step S202, calculating first Swing similarity of a user behavior sequence of a previous day according to the full Swing result. In one embodiment, firstly a time index of the previous day may be determined in the full user behavior sequence, and the user behavior sequence after the time index may be intercepted from the full user behavior sequence. Then, forming an item pair with the historical user behavior sequence based on the user behavior sequence after the time index, so as to calculate Swing similarity of the corresponding item pair, to obtain the first Swing similarity of the user behavior sequence of the previous day.

It is understandable that the user behavior sequence is continuous when recorded, so it is necessary to determine the time index of the previous day. After determining the aforementioned time index, the user behavior sequence after the time index corresponds to the user behavior sequence of the previous day. Further, intercepting the user behavior sequence of the previous day, and forming an item pair with the historical user behavior sequence based on the user behavior sequence of the previous day, and then calculating and obtaining the first Swing similarity of the user behavior sequence of the previous day according to the above formula (1).

Based on the first Swing similarity obtained above, at step S203, performing a fusion of the first Swing similarity and second Swing similarity of a historical user behavior sequence, to obtain a target Swing result. In one embodiment, the first Swing similarity and the second Swing similarity of the historical user behavior sequence are weighted summed to obtain the target Swing result. In some embodiments, the weights in the aforementioned weighted sum operation may be set according to actual task requirements.

Finally, at step S204, utilizing the target Swing result to update the first Swing similarity of the previous day, and using it as a historical Swing result of a next day, to realize a recall in the e-commerce recommendation system. That is, the fused Swing result is used to cover the content of the previous day as a new recall version of the previous day, and it is used as the historical Swing result of the next day to realize the recall in the recommendation system. Accordingly, the second Swing similarity of the historical user behavior sequence in the context of the present application is determined by the historical Swing result of the previous day.

Combined with the above description, it may be seen that the embodiment of the present application performs the full Swing calculation by the full user behavior sequence, so that the full-graph information is retained and the recall is lossless. Furthermore, the embodiment of the present application only needs to calculate the Swing results of the previous day each time, perform a fusion (such as weighted sum) with the historical Swing result and then update the content of the previous day, to use it as the historical Swing results of the next day. This greatly improves the recall efficiency and reduces resource consumption.

In some embodiments, the embodiments of the present application also set hyperparameters in performing the full Swing calculation or calculating the first Swing similarity. Among them, the hyperparameters include at least an update time and/or a time window of the user behavior sequence. This is because the Swing result based on the user behavior sequence within a fixed time window is better, so by setting the hyperparameters such as the update time and/or the time window of the user behavior sequence, the stability of the algorithm and data in the recall may be ensured.

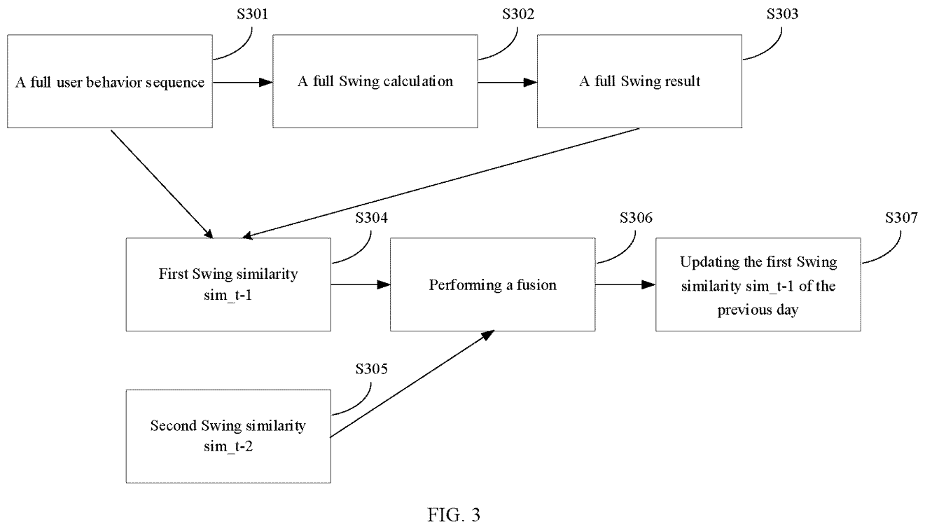

FIG. 3 is an exemplary schematic diagram showing a recall method for an e-commerce recommendation system according to an embodiment of the present application. It is understandable that FIG. 3 is a specific embodiment of the recall method 200 of FIG. 2 above, so the above description of FIG. 2 is also applicable to FIG. 3. As shown in FIG. 3, at step S301, obtaining the full user behavior sequence, which is all user behavior sequences in the database at the current moment. Then, at step S302, performing a full Swing calculation, to obtain a full Swing result at step S303. According to the above, it is available to perform a full Swing calculation based on the above formula (1), to obtain a full Swing result. Through the full calculation, the full-graph information may be retained to ensure lossless recall.

Furthermore, at step S304, calculating first Swing similarity (denoted as sim_t-1) of a user behavior sequence of a previous day, and at step S305, obtaining second Swing similarity (denoted as sim_t-2) of a historical user behavior sequence. Among them, for the first Swing similarity, firstly intercepting the user behavior sequence of the previous day from the full user behavior sequence, and then forming an item pair <i, j> with the historical user behavior sequence based on the user behavior sequence of the previous day, further, calculating and obtaining the first Swing similarity sim_t-1 of the user behavior sequence of the previous day according to the above formula (1). For the second Swing similarity sim_t-2, it may be determined by the historical Swing result of the previous day.

After obtaining the first Swing similarity sim_t-1 and the second Swing similarity sim_t-2, at step S306, performing a fusion of the first Swing similarity sim_t-1 and the second Swing similarity sim_t-2, to obtain a target Swing result. In some embodiments, it is available to perform a weighted sum operation on the first Swing similarity sim_t-1 and the second Swing similarity sim_t-2, to perform the aforementioned fusion. Specifically, it is available to perform the fusion based on weight_t-1*sim_t-1+weight_t-2*sim_t-2, to obtain the target Swing result. Among them, weight_t-1 and weight_t-2 represent weights, which may be set according to actual task requirements.

Further, at step S307, utilizing the target Swing result to update the first Swing similarity of the previous day, and using it as a historical Swing result of a next day, to realize a recall in the e-commerce recommendation system. Based on this, the embodiment of the present application only needs to calculate the Swing result of the previous day, without traversing all user behavior sequences and expanding all item pairs every time, which greatly improves the recall efficiency and reduces resource consumption.

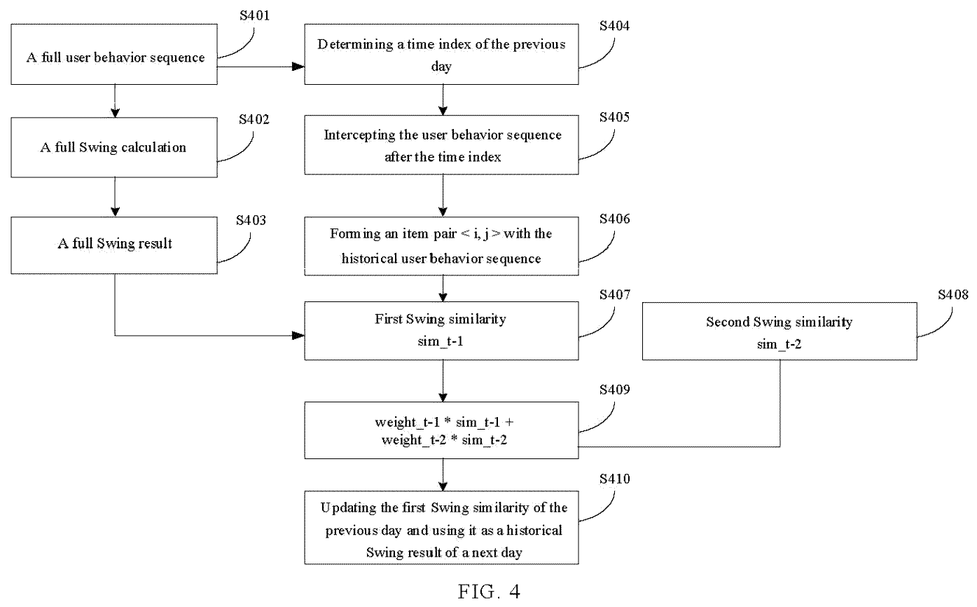

FIG. 4 is an overall exemplary flow block diagram showing a recall method for an e-commerce recommendation system according to an embodiment of the present application. As shown in FIG. 4, at step S401, obtaining a full user behavior sequence, that is, all user behavior sequences in the database at the current moment. Then, at step S402, performing a full Swing calculation, to obtain a full Swing result at step S403.

Furthermore, at step S404, determining a time index of the previous day in the full user behavior sequence. Based on the time index, at step S405, intercepting the user behavior sequence after the time index, that is, the user behavior sequence of the previous day. At step S406, forming an item pair <i, j> with the historical user behavior sequence based on the user behavior sequence of the previous day, and the above formula (1) is used to calculate the Swing similarity, so as to obtain the first Swing similarity sim_t-1 of the user behavior sequence of the previous day at step S407. In addition, at step S408, the second Swing similarity sim_t-2 is obtained by the historical Swing result of the previous day.

Next, at step S409, performing a fusion of the first Swing similarity sim_t-1 and the second Swing similarity sim_t-2 according to weight_t-1*sim_t-1+weight_t-2*sim_t-2, to obtain a target Swing result. Based on the aforementioned target Swing result, at step S410, utilizing the target Swing result to update the first Swing similarity sim_t-1 of the previous day, and using it as a historical Swing result of a next day, to realize a recall in the recommendation system.

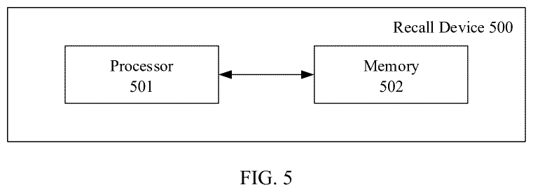

FIG. 5 is an exemplary structural block diagram of a recall device for an e-commerce recommendation system according to an embodiment of the present application. As shown in FIG. 5, the recall device 500 of the present application may include a processor 501 and a memory 502, wherein the processor 501 and the memory 502 connect with each other through a bus. The memory 502 stores program instructions used to recall in the e-commerce recommendation system, and when the program instructions are executed by the processor 501, the method steps described in the above description in conjunction with FIG. 2-FIG. 4 are implemented: performing a full Swing calculation, based on a full user behavior sequence in the e-commerce recommendation system, to obtain a full Swing result; calculating first Swing similarity of a user behavior sequence of a previous day according to the full Swing result; performing a fusion of the first Swing similarity and second Swing similarity of a historical user behavior sequence, to obtain a target Swing result; and utilizing the target Swing result to update the first Swing similarity of the previous day, and using it as a historical Swing result of a next day, to realize a recall in the e-commerce recommendation system.

According to the above description in conjunction with the drawings, those skilled in the art may also understand that the embodiments of the present application may also be implemented by a software program. Therefore, the present application also provides a non-transitory machine-readable medium. The non-transitory machine-readable medium stores thereon computer-readable instructions used to recall in an e-commerce recommendation system, and when the computer-readable instructions are executed by one or more processors, the recall method for an e-commerce recommendation system described in the present application in conjunction with FIG. 2-FIG. 4 is implemented.

Through the description of the above implementation methods, those skilled in the art may clearly understand that each implementation method may be implemented by means of software plus a necessary general hardware platform, or of course by hardware. Based on this understanding, the above technical solution in essence, or the part that contributes to the prior art may be embodied in the form of a software product, and the computer software product may be stored in a computer-readable storage medium, such as ROM/RAM, a magnetic disk, an optical disk, etc., a computer device (which may be a personal computer, a server, or a network device, etc.) including a number of instructions which executes the methods described in each of the embodiments or some parts of the embodiments.

It should be noted that although the operations of the methods of the present application are described in a particular order in the drawings, this does not require or imply that the operations must be performed in this particular order, or that all of the operations shown must be performed to achieve the desired results. On the contrary, the steps depicted in the flowchart may be performed in a different order. Additionally or alternatively, some steps may be omitted, multiple steps may be combined into one step, and/or one step may be decomposed into multiple steps.

The foregoing content may be better understood in accordance with the following articles:

Article A1. A recall method for an e-commerce recommendation system, including:
performing a full Swing calculation, based on a full user behavior sequence in the e-commerce recommendation system, to obtain a full Swing result;
calculating first Swing similarity of a user behavior sequence of a previous day according to the full Swing result;
performing a fusion of the first Swing similarity and second Swing similarity of a historical user behavior sequence, to obtain a target Swing result; and
utilizing the target Swing result to update the first Swing similarity of the previous day, and using it as a historical Swing result of a next day, to realize a recall in the e-commerce recommendation system.

Article A2. The recall method according to Article A1, wherein the user behavior sequence is a list set formed when a user performs target operations on a target item at different times, and the target operations include at least a click operation.

Article A3. The recall method according to Article A1, wherein the first Swing similarity is calculated by the following operations:
determining a time index of the previous day in the full user behavior sequence, and intercepting the user behavior sequence after the time index from the full user behavior sequence;
forming an item pair with the historical user behavior sequence based on the user behavior sequence after the time index; and
calculating Swing similarity of the corresponding item pair, to obtain the first Swing similarity of the user behavior sequence of the previous day.

Article A4. The recall method according to Article A3, wherein the second Swing similarity of the historical user behavior sequence is determined by a historical Swing result of the previous day.

Article A5. The recall method according to Article A4, wherein performing a fusion of the first Swing similarity and the second Swing similarity of the historical user behavior sequence, to obtain the target Swing result, including:
performing a weighted sum operation on the first Swing similarity and the second Swing similarity of the historical user behavior sequence, to obtain the target Swing result.

Article A6. The recall method according to Article A1, further including:
setting hyperparameters in performing the full Swing calculation or calculating the first Swing similarity.

Article A7. The recall method according to Article A6, wherein the hyperparameters includes at least an update time and/or a time window of the user behavior sequence.

Article A8. A recall device for an e-commerce recommendation system, including:
a processor; and
a memory having stored thereon computer instructions used to recall in the e-commerce recommendation system, and when the computer instructions are executed by the processor, the recall device implements the following operations:
performing a full Swing calculation, based on a full user behavior sequence in the e-commerce recommendation system, to obtain a full Swing result;
calculating first Swing similarity of a user behavior sequence of a previous day according to the full Swing result;
performing a fusion of the first Swing similarity and second Swing similarity of a historical user behavior sequence, to obtain a target Swing result; and
utilizing the target Swing result to update the first Swing similarity of the previous day, and using it as a historical Swing result of a next day, to realize a recall in the e-commerce recommendation system.

Article A9. The recall device according to Article A8, wherein the user behavior sequence is a list set formed when a user performs target operations on a target item at different times, and the target operations include at least a click operation.

Article A10. The recall device according to Article A8, wherein the recall device further calculates the first Swing similarity by the following operations:
determining a time index of the previous day in the full user behavior sequence, and intercepting the user behavior sequence after the time index from the full user behavior sequence;
forming an item pair with the historical user behavior sequence based on the user behavior sequence after the time index; and
calculating Swing similarity of the corresponding item pair, to obtain the first Swing similarity of the user behavior sequence of the previous day.

Article A11. The recall device according to Article A10, wherein the second Swing similarity of the historical user behavior sequence is determined by a historical Swing result of the previous day.

Article A12. The recall device according to Article A11, the recall device further obtains the target Swing result by the following operations:
performing a weighted sum operation on the first Swing similarity and the second Swing similarity of the historical user behavior sequence, to obtain the target Swing result.

Article A13. The recall device according to Article A8, wherein the recall device further implements the following operations:
setting hyperparameters in performing the full Swing calculation or calculating the first Swing similarity.

Article A14. The recall device according to Article A13, wherein the hyperparameters includes at least an update time and/or a time window of the user behavior sequence.

Article A15. A non-transitory machine-readable medium having stored thereon computer program instructions used to recall in an e-commerce recommendation system, wherein when the computer program instructions are executed by one or more processors, the following operations are implemented:
performing a full Swing calculation, based on a full user behavior sequence in the e-commerce recommendation system, to obtain a full Swing result;
calculating first Swing similarity of a user behavior sequence of a previous day according to the full Swing result;
performing a fusion of the first Swing similarity and second Swing similarity of a historical user behavior sequence, to obtain a target Swing result; and
utilizing the target Swing result to update the first Swing similarity of the previous day, and using it as a historical Swing result of a next day, to realize a recall in the e-commerce recommendation system.

Article A16. The non-transitory machine-readable medium according to Article A15, wherein further implements the following operations:
determining a time index of the previous day in the full user behavior sequence, and intercepting the user behavior sequence after the time index from the full user behavior sequence;
forming an item pair with the historical user behavior sequence based on the user behavior sequence after the time index; and
calculating Swing similarity of the corresponding item pair, to obtain the first Swing similarity of the user behavior sequence of the previous day.

Article A17. The non-transitory machine-readable medium according to Article A16, wherein the second Swing similarity of the historical user behavior sequence is determined by a historical Swing result of the previous day.

Article A18. The non-transitory machine-readable medium according to Article A17, wherein further implements the following operations:
performing a weighted sum operation on the first Swing similarity and the second Swing similarity of the historical user behavior sequence, to obtain the target Swing result

Article A19. The non-transitory machine-readable medium according to Article A16, wherein further implements the following operations:
setting hyperparameters in performing the full Swing calculation or calculating the first Swing similarity.

Article A20. A non-transitory machine-readable medium according to Article A19, wherein the hyperparameters includes at least an update time and/or a time window of the user behavior sequence.

It should be understood that when the terms “first”, “second”, “third”, “fourth” and so on are used in the claims, the specification and the drawings of the present application, they are only used to distinguish different objects, rather than to describe a particular order. The terms “include” and “include” used in the specification and claims of the present application indicate the existence of the described features, wholes, steps, operations, elements and/or components, but do not exclude the existence or addition of one or more other features, wholes, steps, operations, elements, components and/or their collections thereof.

It should also be understood that the terms used in this specification of the present application are only for the purpose of describing specific embodiments, and are not intended to limit the present application. As used in the specification and claims of the present application, unless the context clearly indicates otherwise, the singular forms of “a”, “an” and “the” are intended to include plural forms. It should also be further understood that the term “and/or” used in the specification and claims of the present application refers to any combination of one or more of the associated listed items and all possible combinations, and includes these combinations.

Although the implementation methods of the present application are as above, the contents are only examples adopted to facilitate the understanding of the present application, and are not intended to limit the scope and application scenarios of the present application. Any technician in the technical field described in the present application may make any modifications and changes in the form and details of the implementation without departing from the spirit and scope disclosed in the present application, but the scope of patent protection of the present application shall still be based on the scope defined by the attached claims.

In addition, the collection and acquisition of various data in the present application complies with relevant laws and regulations and is authorized by the data provider. Any organization or individual that needs to obtain external data must obtain authorization and ensure data security in accordance with the law, and must not illegally collect, use, process, or transmit unauthorized or unprotected data, or illegally buy, sell, provide, or disclose unauthorized or unprotected data.

What is claimed is:

1. A recall method for an e-commerce recommendation system, the recall method comprising:
performing a full Swing calculation, based on a full user behavior sequence in the e-commerce recommendation system, to obtain a full Swing result;
calculating first Swing similarity of a user behavior sequence of a previous day according to the full Swing result;
performing a fusion of the first Swing similarity and second Swing similarity of a historical user behavior sequence, to obtain a target Swing result; and
utilizing the target Swing result to update the first Swing similarity of the previous day, and using it as a historical Swing result of a next day, to realize a recall in the e-commerce recommendation system.

2. The recall method according to claim 1, wherein the user behavior sequence is a list set formed when a user performs target operations on a target item at different times, and the target operations include at least a click operation.

3. The recall method according to claim 1, wherein the first Swing similarity is calculated by the following operations:
determining a time index of the previous day in the full user behavior sequence, and intercepting the user behavior sequence after the time index from the full user behavior sequence;
forming an item pair with the historical user behavior sequence based on the user behavior sequence after the time index; and
calculating Swing similarity of the corresponding item pair, to obtain the first Swing similarity of the user behavior sequence of the previous day.

4. The recall method according to claim 3, wherein the second Swing similarity of the historical user behavior sequence is determined by a historical Swing result of the previous day.

5. The recall method according to claim 4, wherein performing a fusion of the first Swing similarity and the second Swing similarity of the historical user behavior sequence, to obtain the target Swing result, comprising:
performing a weighted sum operation on the first Swing similarity and the second Swing similarity of the historical user behavior sequence, to obtain the target Swing result.

6. The recall method according to claim 1, further comprising:
setting hyperparameters in performing the full Swing calculation or calculating the first Swing similarity.

7. The recall method according to claim 1, wherein the hyperparameters includes at least an update time and/or a time window of the user behavior sequence.

8. A recall device for an e-commerce recommendation system, comprising:
a processor; and
a memory having stored thereon computer instructions used to recall in the e-commerce recommendation system, and when the computer instructions are executed by the processor, the recall device implements the following operations:
performing a full Swing calculation, based on a full user behavior sequence in the e-commerce recommendation system, to obtain a full Swing result;
calculating first Swing similarity of a user behavior sequence of a previous day according to the full Swing result;
performing a fusion of the first Swing similarity and second Swing similarity of a historical user behavior sequence, to obtain a target Swing result; and
utilizing the target Swing result to update the first Swing similarity of the previous day, and using it as a historical Swing result of a next day, to realize a recall in the e-commerce recommendation system.

9. The recall device according to claim 8, wherein the user behavior sequence is a list set formed when a user performs target operations on a target item at different times, and the target operations include at least a click operation.

10. The recall device according to claim 8, wherein the recall device further calculates the first Swing similarity by the following operations:
determining a time index of the previous day in the full user behavior sequence, and intercepting the user behavior sequence after the time index from the full user behavior sequence;
forming an item pair with the historical user behavior sequence based on the user behavior sequence after the time index; and
calculating Swing similarity of the corresponding item pair, to obtain the first Swing similarity of the user behavior sequence of the previous day.

11. The recall device according to claim 8, wherein the second Swing similarity of the historical user behavior sequence is determined by a historical Swing result of the previous day.

12. The recall device according to claim 11, the recall device further obtains the target Swing result by the following operations:
performing a weighted sum operation on the first Swing similarity and the second Swing similarity of the historical user behavior sequence, to obtain the target Swing result.

13. The recall device according to claim 8, wherein the recall device further implements the following operations:
setting hyperparameters in performing the full Swing calculation or calculating the first Swing similarity.

14. The recall device according to claim 13, wherein the hyperparameters includes at least an update time and/or a time window of the user behavior sequence.

15. A non-transitory machine-readable medium having stored thereon computer program instructions used to recall in an e-commerce recommendation system, wherein when the computer program instructions are executed by one or more processors, the following operations are implemented:
performing a full Swing calculation, based on a full user behavior sequence in the e-commerce recommendation system, to obtain a full Swing result;
calculating first Swing similarity of a user behavior sequence of a previous day according to the full Swing result;
performing a fusion of the first Swing similarity and second Swing similarity of a historical user behavior sequence, to obtain a target Swing result; and
utilizing the target Swing result to update the first Swing similarity of the previous day, and using it as a historical Swing result of a next day, to realize a recall in the e-commerce recommendation system.

16. The non-transitory machine-readable medium according to claim 15, wherein further implements the following operations:
determining a time index of the previous day in the full user behavior sequence, and intercepting the user behavior sequence after the time index from the full user behavior sequence;
forming an item pair with the historical user behavior sequence based on the user behavior sequence after the time index; and
calculating Swing similarity of the corresponding item pair, to obtain the first Swing similarity of the user behavior sequence of the previous day.

17. The non-transitory machine-readable medium according to claim 16, wherein the second Swing similarity of the historical user behavior sequence is determined by a historical Swing result of the previous day.

18. The non-transitory machine-readable medium according to claim 17, wherein further implements the following operations:
performing a weighted sum operation on the first Swing similarity and the second Swing similarity of the historical user behavior sequence, to obtain the target Swing result.

19. The non-transitory machine-readable medium according to claim 16, wherein further implements the following operations:
setting hyperparameters in performing the full Swing calculation or calculating the first Swing similarity.

20. A non-transitory machine-readable medium according to claim 19, wherein the hyperparameters includes at least an update time and/or a time window of the user behavior sequence.
